(19) United States
(12) Patent Application Publication
(10) Pub. No.: US 2026/0313047 A1
(43) Pub. Date: Oct. 8, 2026

(54) RELAY DEVICE, RELAY METHOD, AND NON-TRANSITORY COMPUTER-READABLE STORAGE MEDIUM STORING PROGRAM

(71) Applicant: NTT, Inc., Tokyo (JP)

(72) Inventors: Hiroki IWASAWA, Tokyo (JP); Kazuhiro TOKUNAGA, Tokyo (JP); Takuya TOJO, Tokyo (JP); Seiya KOMATSU, Tokyo (JP)

(21) Appl. No.: 19/484,940

(22) PCT Filed: May 31, 2023
(86) PCT No.: PCT/JP2023/020280

§ 371 Date: Nov. 17, 2025

(51) Int. Cl. H04L 69/18; H04L 61/2503; H04L 61/4511; H04W 60/04

(52) U.S. Cl. CPC H04L 69/18; H04L 61/2503; H04L 61/4511; H04W 60/04

(57) ABSTRACT

A relay device to be included in a communication system including a plurality of relay devices connected via one or more networks includes an address management unit that registers at least transmission/reception addresses of communication between terminals, an address translation unit that translates a destination address of a packet received from a terminal, and a transport unit that receives a packet after destination address translation from the address translation unit and transfers data of the packet by using a transport connection between the relay devices by referring to the address management unit.

### TECHNICAL FIELD

The present invention relates to a communication system in which a plurality of terminals (applications) perform communication using one or more transport protocols via a plurality of networks.

### BACKGROUND ART

Development of autonomous driving technology of automobiles has progressed, and conditional traveling at Level 4, in which a system is mainly responsible for driving operation, is beginning to be approved in Japan.

Regarding autonomous driving technology, remote monitoring, control and assistance, and the like of a vehicle are required from the viewpoint of accident prevention. In monitoring a vehicle, it is necessary for an observer to be able to receive images captured by a plurality of cameras inside and outside the vehicle in real time. In addition, it is necessary to perform control and assistance without latency or loss. In addition, communication having various requirements due to an infotainment system such as navigation and entertainment is assumed to occur.

On the other hand, in current mobile communication such as LTE and 5G, it is difficult to reliably satisfy these communication requirements with one line under congestion and radio wave conditions.

Under such circumstances, conventional technologies have proposed MPTCP or multipath extension for QUIC using a plurality of lines in combination in a transport layer, and a mechanism using it, as a mechanism for achieving low latency and stabilization.

### CITATION LIST

### Non-Patent Literature

Non-Patent Literature 1:“The MASQUE Protocol,” draft-schinazi-masque-00 https://datatracker.ietf.org/doc/html/draft-schinazi-masque-00
Non-Patent literature 2:“Tunneling Internet protocols inside QUIC,” draft-piraux-quic-tunnel-03 https://datatracker.ietf.org/doc/html/draft-piraux-quic-tunnel-03
Non-Patent Literature 3:“Enabling application policy-awareness in Multipath QUIC,” draft-an-multipath-quic-application-policy-00 https://datatracker.ietf.org/doc/html/draft-an-multipath-quic-application-policy-00#ref-MPQUIC-Scheduler

### SUMMARY OF INVENTION

### Technical Problem

In the conventional technologies, by providing a communication function using HTTP/3, QUIC, MPTCP, or the like on the terminal side, use of a plurality of lines and multiplexing of communication are implemented. Therefore, the load on the terminal increases. In addition, use of resources (computational resources, network resources, and the like) becomes inefficient.

The present invention has been made in view of the above points, and an object of the present invention is to provide a technology capable of improving efficiency of resource use in a communication system in which communication is performed between terminals using one or more transport protocols.

### Solution to Problem

According to the disclosed technology, provided is a relay device to be included in a communication system including a plurality of relay devices connected via one or more networks, including
an address management unit that registers at least transmission/reception addresses of communication between terminals,
an address translation unit that translates a destination address of a packet received from a terminal, and
a transport unit that receives a packet after destination address translation from the address translation unit and transfers data of the packet by using a transport connection between the relay devices by referring to the address management unit.

### Advantageous Effects of Invention

According to the disclosed technology, it is possible to improve efficiency of resource use in a communication system in which communication is performed between terminals using one or more transport protocols.

### BRIEF DESCRIPTION OF DRAWINGS

FIG. 1 is a diagram illustrating a configuration example of a communication system.

FIG. 2 is a diagram illustrating a configuration example of a relay device 10.

FIG. 3 is a sequence diagram illustrating a TCP communication transfer start method.

FIG. 4 is a sequence diagram illustrating a UDP communication transfer method 1.

FIG. 5 is a sequence diagram illustrating a UDP communication transfer method 2.

FIG. 6 is a sequence diagram illustrating an IP communication transfer method.

FIG. 7 is a flowchart illustrating a method for switching among UDP and IP communication transfer methods.

FIG. 8 is a sequence diagram of performing UDP transfer using a logical path.

FIG. 9 is a diagram illustrating a configuration example of a communication system according to Example 2.

FIG. 10 is a sequence diagram in Example 2.

FIG. 11 is a diagram illustrating a hardware configuration example of a device.

### DESCRIPTION OF EMBODIMENTS

Hereinbelow, an embodiment of the present invention (the present embodiment) will be described with reference to the drawings. The embodiment to be described below is illustrative only, and the embodiment to which the present invention is applied is not limited to the following embodiment.

Described here is a technology related to a relay device that terminates a communication flow, multiplexes the communication flow into one connection, and transfers the connection in an environment in which a plurality of communication terminals (applications) perform communication using various transport protocols via a plurality of networks to improve use efficiency of computational resources of the terminals and use efficiency of the networks.

In the following, first, conventional technologies and the problems thereof will be described in detail, and then the above-described technology of the present embodiment will be described in detail. Note that, regarding the conventional technologies, the technologies themselves disclosed in the non-patent literature is publicly known, but the following explanation of the conventional technologies and explanation of the problems are not publicly known.

### About Conventional Technologies

As described above, conventional technologies have proposed MPTCP or multipath extension for QUIC using a plurality of lines in combination in a transport layer, and a mechanism using it, as a mechanism for achieving low latency and stabilization. Specifically, there are the following conventional technologies.

<Conventional Technology 1: Multiplexed Application Substrate over QUIC Encryption (MASQUE), 2020>

Conventional Technology 1 is a technology disclosed in Non-Patent Literature 1. MASQUE in Conventional Technology 1 is a mechanism that proxies encrypted stream and datagram communication using HTTP, and is discussed in the standardization working group of IETF.

In MASQUE, with use of the CONNECT method for HTTP including destination information, the HTTP/3 proxy that receives the transfer request from the client transfers the QUIC stream frame or datagram frame to the intended destination (in the case of HTTP/2 or earlier versions, TCP or UDP is used).

<Conventional Technology 2: Tunneling Internet protocols inside QUIC, 2019>

Conventional Technology 2 is a technology disclosed in Non-Patent Literature 2. Conventional Technology 2 defines the following Method 1 and Method 2 as tunneling methods using QUIC.
Method 1: The transfer source packet is stored directly in the payload of the datagram frame. The signaling method is not particularly specified.
Method 2: The transfer source packet is stored in the datagram frame, with the protocol type and 2 bytes of tag added to the head of the datagram frame. Examples of the tag used include a time stamp and a packet number.

In Conventional Technology 2, a session participation method of a plurality of paths is also defined.

<Conventional Technology 3: (enhanced) Access Traffic Steering, Switching, and Splitting ((e)ATSSS)>

Conventional Technology 3 is a technology disclosed in Non-Patent Literature 3. ATSSS in Conventional Technology 3 is a standard in which the MPTCP proxy function is provided in the UE and the 5G UPF, and the 3GPP access and the non-3GPP access are used between the UE and the UPF using MPTCP. In eATSSS, support for communication other than TCP communication, addition of a transfer mode, and the like using multipath extension for QUIC have been studied.

### About Problems

In the conventional technology, by providing a communication function using HTTP/3, QUIC, MPTCP, or the like on the terminal side, use of a plurality of lines and multiplexing of communication are implemented. Therefore, in particular, in a case where there are a plurality of terminals in the same vehicle, the following problems occur.
Conventional applications using TCP or UDP cannot be used as they are.
A terminal, such as an in-vehicle system, in which hardware resources including a CPU and a memory are not sufficient, has to perform high-load processing such as encryption processing.
Since respective terminals perform management of a connection such as QUIC, MPTCP, and the like, respective terminals perform quality management and congestion control of a plurality of lines separately, and inefficiency in the use of computational resources and networks occurs.

Hereinbelow, a configuration and operation of a system/device according to the present embodiment for solving the above problems will be described.

### System Configuration Example

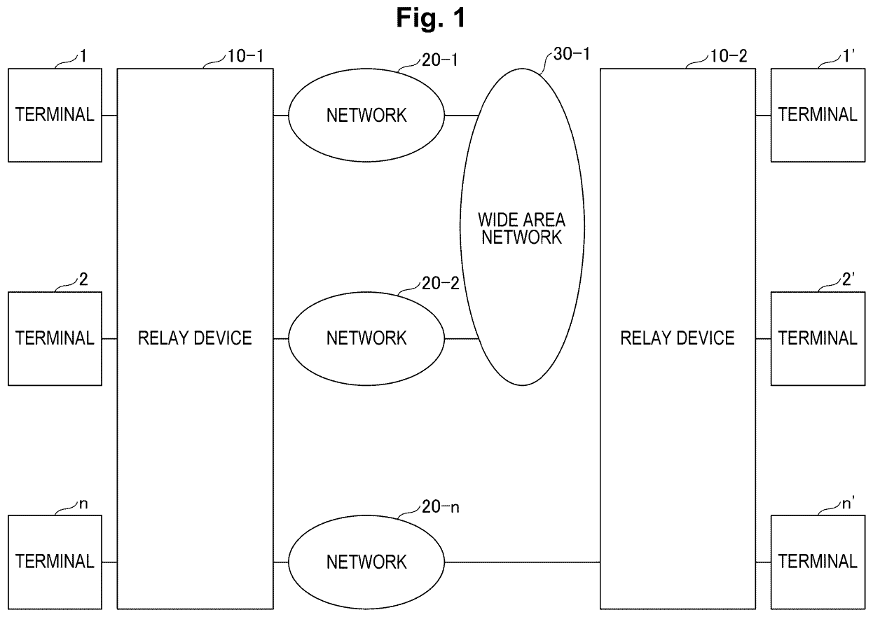

FIG. 1 illustrates a configuration example of a communication system according to the present embodiment.

As illustrated in FIG. 1, the communication system includes a relay device 10-1 and a relay device 10-2. The relay device 10-1 and the relay device 10-2 are connected via a plurality of networks 20-1 to 20-m. In addition, in the example in FIG. 1, the networks 20-1 to 20-2 connected to the relay device 10-1 are connected to a wide area network 30-1, and the wide area network 30-1 is connected to the relay device 10-2.

Terminals 1 to n are connected to the relay device 10-1, and terminals 1′ to n′ are connected to the relay device 10-2.

That is, the terminals 1 to n communicate with the terminals 1′ to n′ via the relay device 10-1, one or more networks, and the relay device 10-2. Note that the terminals and the relay devices may be virtualized and provided in the same physical terminal. Hereinbelow, each example will be described using an example in which communication is performed from the terminal 1 to the terminal 1′. Examples 1 and 2 can be implemented in combination. In addition, transfer methods 1 and 2, an IP transfer method, and a transfer method by adding a path or a connection in Example 1 can be implemented in any combination.

### Example 1

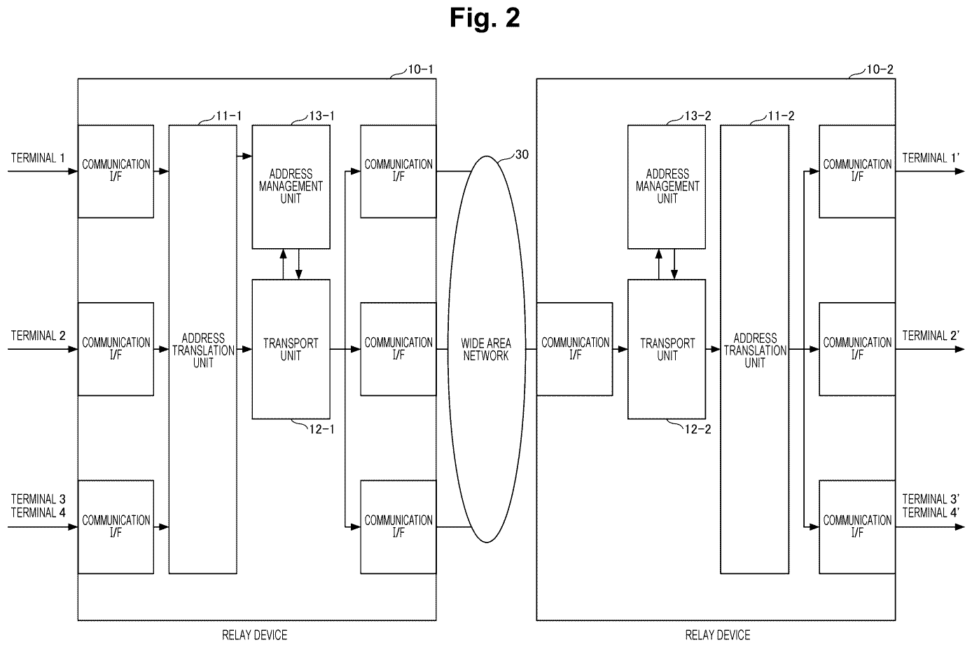

In Example 1, a transfer method using address translation will be described. FIG. 2 illustrates a configuration example of the relay device 10-1 and the relay device 10-2 according to Example 1. Since the relay device 10-1 and the relay device 10-2 have basically the same configuration, “−1” and “−2” will be omitted here for description.

As illustrated in FIG. 2, the relay device 10 includes a communication I/F connected to a terminal, an address translation unit 11, an address management unit 13, a transport unit 12, and a communication I/F connected to one or more networks.

The address translation unit 11 performs address translation. The address management unit 13 manages transmission/reception addresses (a source address and a destination address) between terminals. The transport unit 12 terminates communication with a terminal in L4, multiplexes the communication from one or more terminals, and transfers the communication via a plurality of networks.

Hereinbelow, the operation will be described using an example in which the transport unit 12-1 of the relay device 10-1 and the transport unit 12-2 of the relay device 10-2 are connected by one QUIC connection using a plurality of paths.

### Example 1: TCP Communication Transfer Start Method

First, a TCP communication transfer start method will be described.

TCP communication between the terminals is transparently terminated by performing address translation in the relay device 10, and the TCP communication between the terminals is mapped on the stream frame of the QUIC connection connected between the relay devices 10 and transferred. In the case of using TCP, SCTP, or another protocol, the transfer function can be achieved by assigning an ID and offset information equivalent to those of the stream frame.

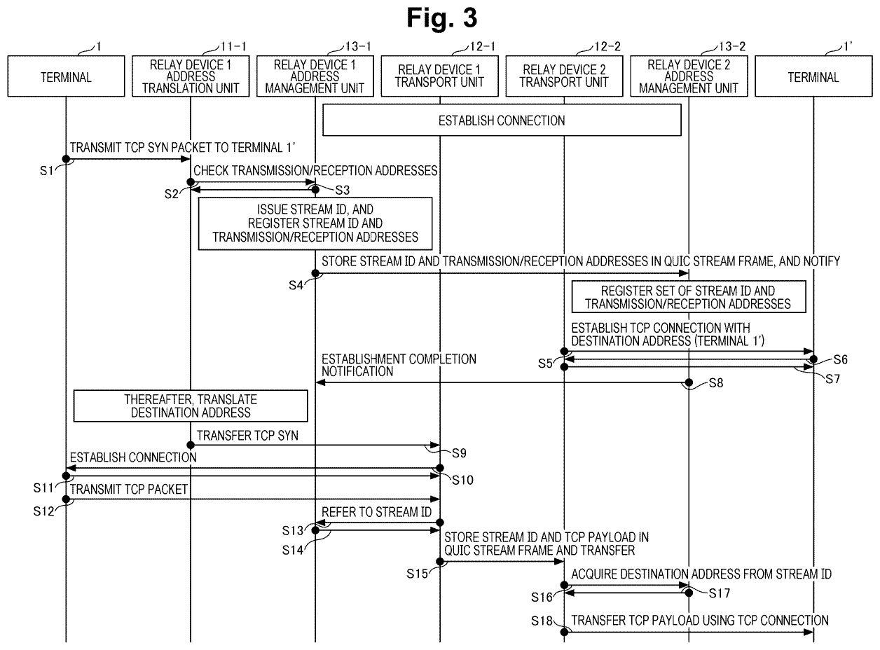

FIG. 3 is a sequence diagram illustrating a processing procedure of a TCP communication transfer start method. In the example illustrated in FIG. 3, reception of a TCP SYN packet is a trigger, but a TCP connection may be established first between the terminal 1 and the relay device 10-1.

In addition, in the procedure illustrated in FIG. 3, freely-selected TCP communication can be transferred, but only an address to be transferred may be registered in the address management unit 13 in advance, and other communication may be transferred in the form of the IP packet without termination in L4. Hereinbelow, when simply referred to as an “address”, it means a set of an IP address and a port number of TCP/UDP.

Note that the TCP connection that starts transfer in the direction from the terminal 1′ to the terminal 1 can be achieved by performing the procedure of FIG. 3 in the reverse direction.

With respect to the end of transfer of the TCP communication, the disconnection of the TCP connection in either the terminal 1 or the terminal 1′ is a trigger, and the relay devices 10 delete the address registration information in a procedure similar to each other, and the TCP connection is disconnected in the other of the terminal 1 and the terminal 1′.

Hereinbelow, the processing procedure will be described with reference to the sequence diagram of FIG. 3. In the following sequence diagrams, the relay device 10-1 is referred to as a relay device 1, and the relay device 10-2 is referred to as a relay device 2 for convenience of description.

Between the relay devices 10, a QUIC connection is established in advance via one or more networks using a protocol such as MPTCP, MPQUIC, or the like.

In S1, the terminal 1 transmits a SYN packet for a connection establishment request to the terminal 1′. The address translation unit 11-1 of the relay device 10-1 receives the SYN packet.

In S2 to S3, the address management unit 13-1 checks whether transmission/reception addresses information of the SYN packet is registered, and if the transmission/reception addresses information is not registered, an unused QUIC stream ID is issued and registered together with the transmission/reception addresses information. The stream ID may be referred to as a flow identifier.

In a case where new registration is performed in the address management unit 13-1, in S4, the address management unit 13-1 uses the QUIC connection between the relay devices 10 to store the issued stream ID and the transmission/reception addresses in the stream frame, thereby notifying the address management unit 13-2 of the relay device 10-2 of these. In the address management unit 13-2, the stream ID and the transmission/reception addresses are registered.

In a case where the addresses of the stream communication are notified from the relay device 10-1, the transport unit 12-2 of the relay device 10-2 establishes a TCP connection with the notified destination address (terminal 1′) in S5 to S7.

In a case where the TCP connection with the terminal 1′ can be normally established, the relay device 10-2 notifies the relay device 10-1 of the establishment completion in S8. Thereafter, the address translation unit 11-1 of the relay device 10-1 translates the destination address of the TCP communication from the terminal 1 into one that is addressed to the transport unit 12-1 of the relay device 10-1. In S4 and S8, for convenience of explanation, the communication is illustrated as if it were communication between the address management units, but in fact, the communication is performed on the QUIC connection established between the transport units.

In S9, the SYN packet received first is transferred to the transport unit 12-1, and in S10 to S11, a TCP connection is established between the terminal 1 and the transport unit 12-1 of the relay device 10-1.

If the TCP connection with the terminal 1′ is failed in the relay device 10-2, a connection failure notification is provided to the relay device 10-1, and the relay device 10-1 transmits a TCP RST packet to the terminal 1 and ends the processing.

Thereafter, in S12, the TCP packet transmitted from the terminal 1 is subjected to address translation in the relay device 10-1 and transferred to the transport unit 12-1.

In S13 to S14, the transport unit 12-1 refers to the address management unit 13-1 for the stream ID (acquires the stream ID from the address management unit 13-1) based on the source address information, and in S15, stores the referred stream ID and the TCP payload data in the stream frame by using the QUIC connection between the relay devices 10 and transfers the stream frame to the relay device 10-2.

The transport unit 12-2 of the relay device 10-2 that has received the QUIC stream frame acquires the destination address based on the stream ID from the address management unit 13-2 (S16 to S17), and transfers the TCP payload data again using the connected TCP connection (S18).

TCP ACK and other data in the direction from the terminal 1′ to the terminal 1 can be transferred by performing a similar procedure from the relay device 10-2 to the relay device 10-1.

### Example 1: UDP Communication Transfer Method 1

Next, a UDP communication transfer method 1 will be described. In the UDP communication transfer method 1, similarly to the TCP communication transfer method, a flow is identified by mapping a unique datagram ID and transmission/reception addresses. In the real-time video distribution application, stream communication is performed using RTP or the like as a higher-level protocol of UDP. The datagram ID may be referred to as a flow identifier.

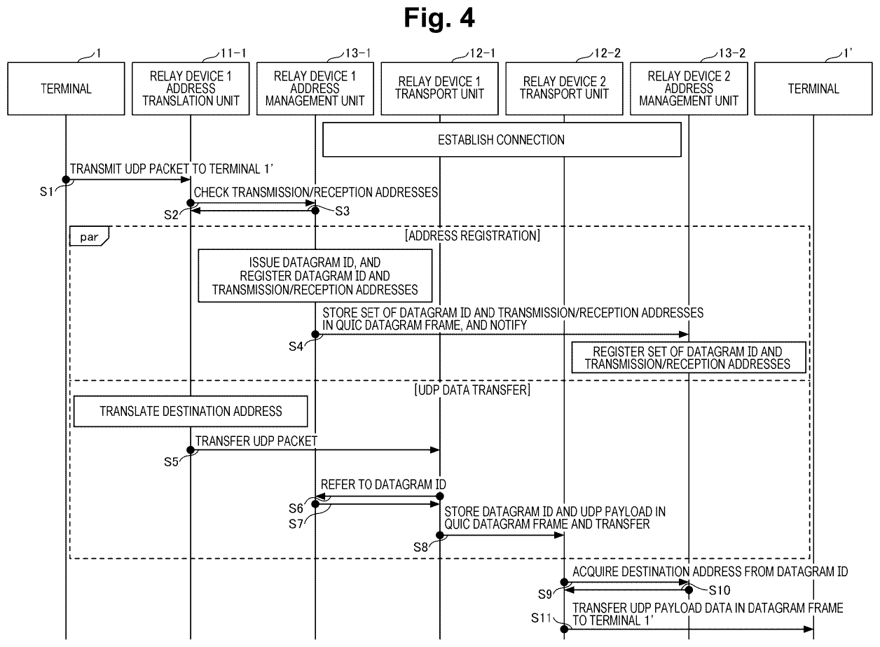

FIG. 4 is a sequence diagram illustrating a procedure of the UDP communication transfer method 1. Note that, in the sequence diagram, “par” and a dotted frame mean that the processing in the dotted frame is performed for a plurality of terminals in parallel.

At the end of transfer of UDP communication, since there is no connection management unlike the case of the TCP communication, registered address information is deleted using timeout processing or the like.

Hereinbelow, the processing procedure will be described with reference to the sequence diagram of FIG. 4.

Between the relay devices 10, a QUIC connection is established in advance via one or more networks using a protocol such as MPTCP, MPQUIC, or the like.

In S1, the terminal 1 transmits a UDP packet to the terminal 1′. The address management unit 13-1 of the relay device 10-1 checks whether transmission/reception addresses information of the UDP packet is registered, and if the transmission/reception addresses information is not registered, a unique datagram ID is issued and registered together with the transmission/reception addresses information (S2 to S3).

In a case where new registration is performed in the address management unit 13-1, in S4, the address management unit 13-1 uses the QUIC connection between the relay devices 10 to store the issued datagram ID and the transmission/reception addresses in the datagram frame, thereby notifying the address management unit 13-2 of the relay device 10-2 of these. In the address management unit 13-2, the datagram ID and the transmission/reception addresses are registered.

The relay device 10-1 can start UDP packet transfer in parallel without waiting for completion of address registration in the relay device 10-2. However, in a case where the UDP packet is transferred and arrives at the relay device 10-2 before the address registration, the transfer destination address is unknown in the relay device 10-2. Therefore, it is preferable to perform processing such as buffering for a certain period of time in either of the relay devices 10-1 and 10-2.

The address translation unit 11-1 of the relay device 10-1 translates the destination address of the UDP communication from the terminal 1 into one that is addressed to the transport unit 12-1 of the relay device 10-1, and in S5, the UDP packet is transferred to the transport unit 12-1.

In S6 to S8, the transport unit 12-1 refers to the datagram ID based on the source address information, stores the referred datagram ID and the UDP payload data in the datagram frame by using the QUIC connection between the relay devices 10, and transfers the datagram frame to the relay device 10-2.

In S9 to S11, the transport unit 12-2 of the relay device 10-2 that has received the datagram frame acquires the destination address based on the datagram ID from the address management unit 13-2, and transfers the payload data again to the destination address (terminal 1′) by using the UDP communication.

Note that UDP communication in the direction from the terminal 1′ to the terminal 1 can be similarly performed from the relay device 10-2 to the relay device 10-1 by switching the transmission/reception addresses.

### Example 1: UDP Communication Transfer Method 2

Next, a UDP communication transfer method 2 will be described. In the UDP communication transfer method 2, transfer is performed by directly storing transmission/reception addresses information and UDP payload data in the QUIC datagram frame. Since there is no state management unlike the case of the transfer method 1, the latency time until the start of transfer can be shortened and the processing of the relay device 10 can also be simplified, but the packet overhead is increased by 12 bytes in the case of IPv4 at the minimum and by 36 bytes in the case of IPv6 at the minimum for the transmission/reception IP addresses and port numbers.

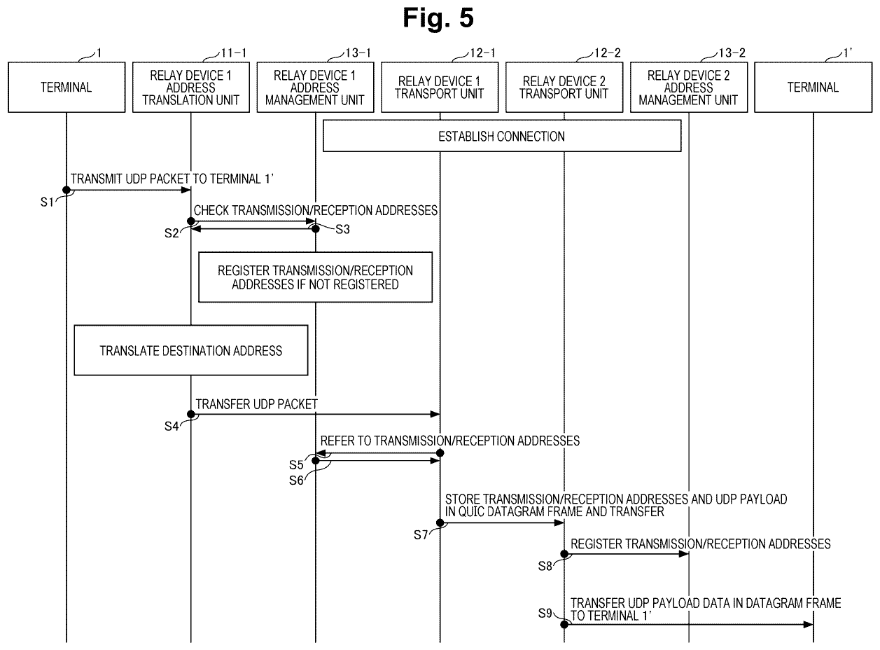

FIG. 5 is a sequence diagram illustrating a procedure of the UDP communication transfer method 2. Note that, at the end of transfer of UDP communication, since there is no connection management unlike the case of the TCP communication, registered address information is deleted using timeout processing or the like.

Hereinbelow, the processing procedure will be described with reference to the sequence diagram of FIG. 5.

Between the relay devices 10, a QUIC connection is established in advance via one or more networks using a protocol such as MPTCP, MPQUIC, or the like.

In S1, the terminal 1 transmits a UDP packet to the terminal 1′. The address management unit 13-1 of the relay device 10-1 checks whether the transmission/reception addresses information of the UDP packet is registered, and if not registered, the transmission/reception addresses information is registered (S2 to S3).

The address translation unit 11-1 of the relay device 10-1 translates the destination address of the UDP communication from the terminal 1 into one that is addressed to the transport unit 12-1 of the relay device 10-1, and in S4, the UDP packet is transferred to the transport unit 12-1.

In S5 to S7, the transport unit 12-1 acquires the destination address information based on the source address information, stores the transmission/reception addresses information and the UDP payload data in the datagram frame by using the QUIC connection between the relay devices 10, and transfers the datagram frame to the relay device 10-2.

The relay device 10-2 that has received the datagram frame registers the transmission/reception addresses information stored in the datagram frame in a case where the transmission/reception addresses information is not registered in the address management unit 13-2 (S8).

In S9, the transport unit 12-2 of the relay device 10-2 transfers the payload data again to the destination address (terminal 1′) in the datagram frame by using the UDP communication.

UDP communication in the direction from the terminal 1′ to the terminal 1 can be similarly performed from the relay device 10-2 to the relay device 10-1 by switching the transmission/reception addresses.

### Example 1: IP Communication Transfer Method

Next, an IP communication transfer method will be described. Some applications overcome the restrictions of a maximum transmission unit (MTU) by performing IP fragmentation. If such an application is terminated in L4 in the relay device 10, fragment reconstruction and division processing are additionally required. Therefore, here, the IP fragmented communication is transferred in the form of the IP packet.

In the transfer of the IP communication, state management and address management are unnecessary, but since it is necessary to transfer the IP header and the transport layer header such as TCP and UDP as they are, the overhead of the header increases and the transfer efficiency decreases.

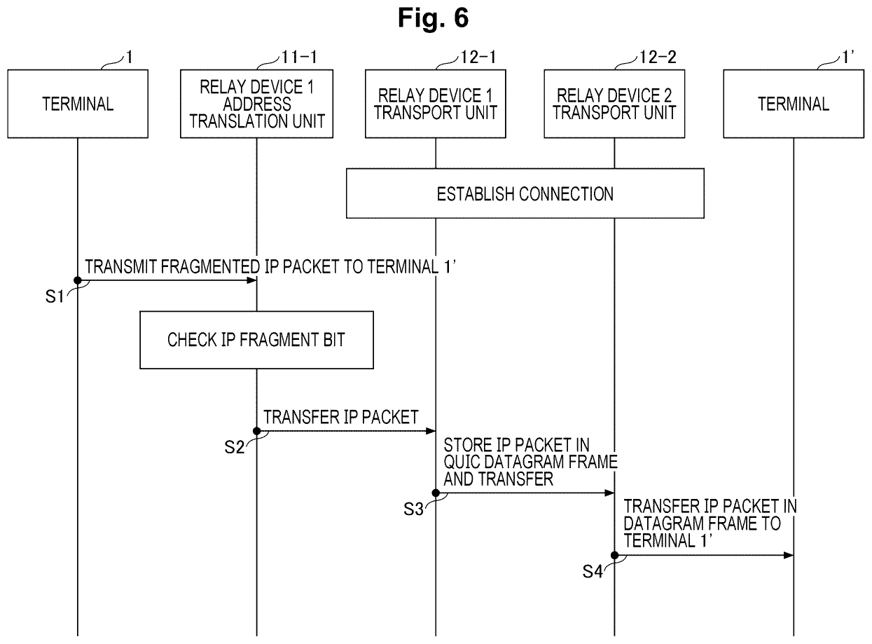

Hereinbelow, the processing procedure will be described with reference to the sequence diagram of FIG. 6.

Between the relay devices 10, a QUIC connection is established in advance via one or more networks using a protocol such as MPTCP, MPQUIC, or the like.

In S1, the terminal 1 transmits an IP packet to the terminal 1′. The address translation unit 11-1 of the relay device 10-1 refers to the fragment bit of the header of the IP packet received from the terminal 1, and transfers the IP packet as it is to the transport unit 12-1 in S2 in a case where the fragmentation is enabled.

In S3, the transport unit 12-1 uses the QUIC connection between the relay devices 10 to store the IP packet as it is in the payload of the QUIC datagram frame and transfer the datagram frame to the relay device 10-2.

In S4, the transport unit 12-2 of the relay device 10-2 extracts the IP packet from the datagram frame and transfers the IP packet to the terminal 1′ on the basis of the destination address information.

### Example 1: Switching among UDP and IP Communication Transfer Methods

Next, switching among UDP and IP communication transfer methods will be described.

Which method is suitable among the UDP communication transfer methods 1 and 2 and the IP communication transfer method differs depending on the application.

For example, for an application in which the packet is a short packet such as DNS, the number of times of communication between the server and the client is small, and a response speed is important, the UDP transfer method 2 is suitable.

On the other hand, for an application in which the packet is a long packet and the amount of transmission data is large such as real-time video streaming, the UDP transfer method 1 is effective from the viewpoint of transfer efficiency.

A transfer method suitable for each flow (application) as described above may be set in the address management unit 13 of the relay device 10 for each flow.

In addition, it is also possible to dynamically switch the transfer method on the basis of the packet payload length or the number of times of transfer.

For example, in a case where the UDP payload length before transfer is sufficiently short, the overhead of the header can be ignored, and thus, the UDP transfer method 2 is used. In a case where the sum of the UDP payload length and the transmission/reception addresses length exceeds the maximum payload length of the QUIC packet, the UDP transfer method 1 is used.

In a case where none of the cases is applicable, the number of times of packet transfer is measured in each certain period. In a case where the number of times of packet transfer is equal to or larger than a threshold, that is, data transfer is frequently performed, the UDP transfer method 1 is used, and otherwise, the UDP transfer method 2 is used.

Further, by adding an identifier indicating which transfer method is used to the head of the QUIC datagram frame, decoding can be performed in the reception relay device 10-2 regardless of which transfer method is used.

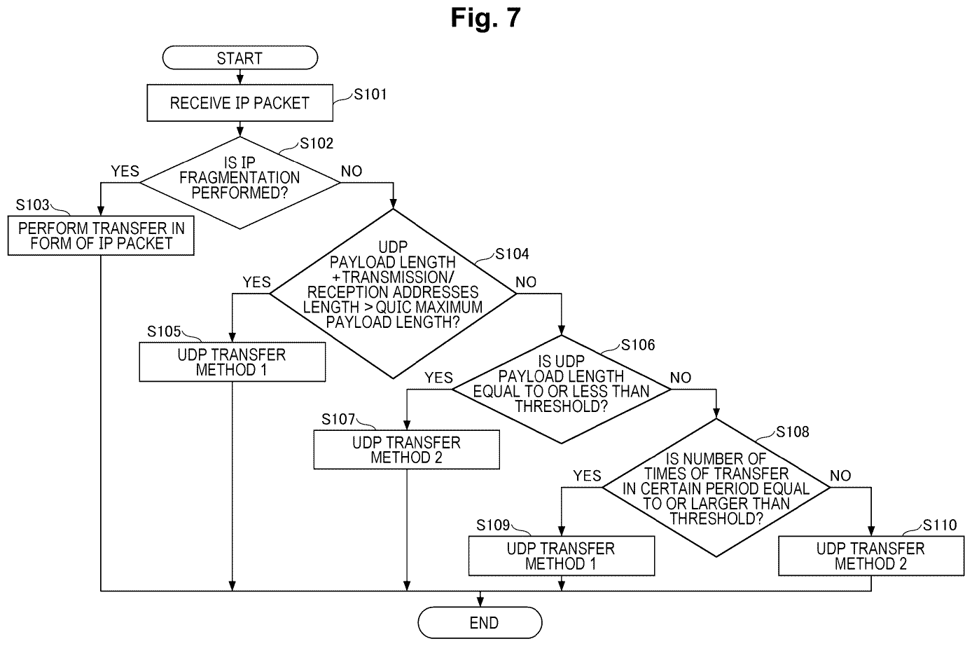

A processing procedure for the above-described dynamic switching will be described with reference to a flowchart of FIG. 7. Note that the subject of the determination in the following flowchart is, for example, the address translation unit 11.

In S101, the relay device 10-1 receives an IP packet. If IP fragmentation is performed, the processing proceeds to S103 (Yes in S102), and if IP fragmentation is not performed, the processing proceeds to S104 (No in S102).

In S103, the relay device 10-1 determines to perform transfer in the form of the IP packet. In S104, the relay device 10-1 determines whether “(UDP payload length+transmission/reception addresses length)>QUIC maximum payload length” is established, and if Yes, the processing proceeds to S105, and if No, the processing proceeds to S106.

In S105, the relay device 10-1 determines to perform transfer using the UDP transfer method 1.

In S106, the relay device 10-1 determines whether the UDP payload length is equal to or less than a threshold. If Yes, the processing proceeds to S107, and if No, the processing proceeds to S108. In S107, the relay device 10-1 determines to perform transfer using the UDP transfer method 2.

In S108, the relay device 10-1 determines whether the number of times of transfer in a certain period is equal to or larger than a threshold. If Yes, the processing proceeds to S109, and if No, the processing proceeds to S110.

In S109, the relay device 10-1 determines to perform transfer using the UDP transfer method 1. In S110, the relay device 10-1 determines to perform transfer using the UDP transfer method 2.

### Example 1: Communication Transfer Method by Adding Path or Connection

In the foregoing transfer methods, it is necessary to add ID information to a packet when a datagram ID is used. Here, a method of performing transfer without packet overhead by newly allocating a logical path or a connection to communication using TCP, UDP, or another protocol to be transferred will be described.

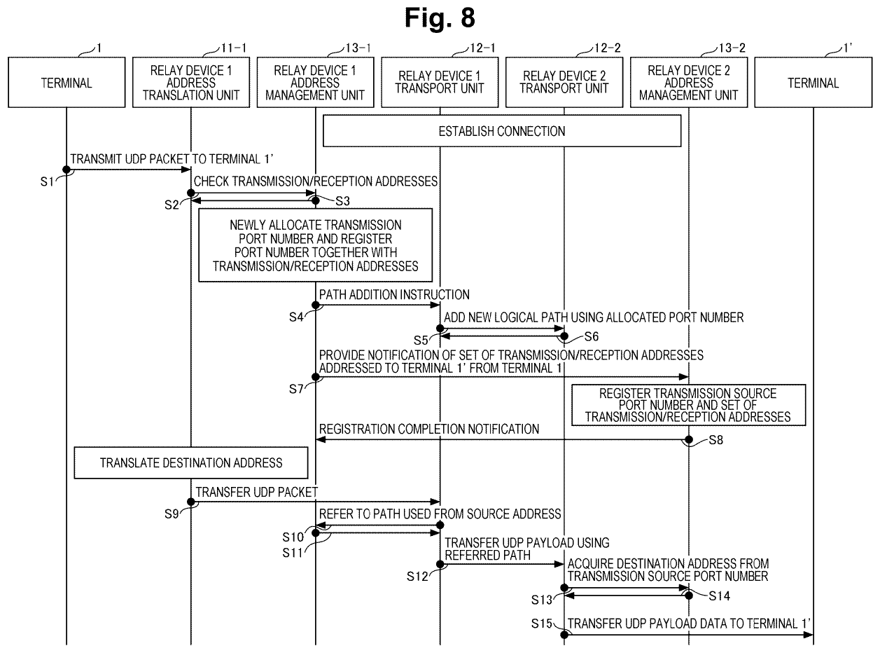

FIG. 8 illustrates a sequence of performing UDP transfer using a logical path. In this case, the relay device 10-1 issues a port number used for QUIC connection instead of the datagram ID, and adds a new path using the issued port number. In addition, a transmission source port number and transmission/reception addresses to be transferred are associated with each other, and a UDP payload is transferred using the new path.

In a case where a connection is used, a QUIC connection for a TCP, UDP, or IP flow to be transferred is added, and a connection ID and transmission/reception addresses to be transferred are associated with each other.

A specific processing procedure in the case of using a logical path will be described with reference to FIG. 8.

Between the relay devices 10, a QUIC connection is established in advance via one or more networks using a protocol such as MPTCP, MPQUIC, or the like.

In S1, the terminal 1 transmits a UDP packet to the terminal 1′. The address management unit 13-1 of the relay device 10-1 checks whether the transmission/reception addresses information of the UDP packet is registered, and if not registered, newly allocates a transmission port number to be used between the relay devices 10 and registers the port number together with the transmission/reception addresses (S2 to S3).

In S4, the address management unit 13-1 issues a path addition instruction to the transport unit 12-1. In S5 to S6, a new logical path is added between the relay devices 10 using the allocated port number.

In S7, the address management unit 13-1 notifies the address management unit 13-2 of the set of transmission/reception addresses addressed to the terminal 1′ from the terminal 1 by using the added logical path. The address management unit 13-2 registers the transmission source port number and the set of transmission/reception addresses. In S8, the address management unit 13-2 transmits a registration completion notification to the address management unit 13-1.

Thereafter, the address translation unit 11-1 of the relay device 10-1 translates the destination address of the UDP communication from the terminal 1 into one that is addressed to the transport unit 12-1 of the relay device 10-1, and in S9, the UDP packet is transferred to the transport unit 12-1.

In S10 to S12, the transport unit 12-1 refers to the path used from the source address, and transfers the UDP payload from the terminal 1 to the relay device 10-2 using the referred path.

In S13 to S15, the transport unit 12-2 acquires the destination address from the transmission source port number and transfers the UDP payload data to the terminal 1′.

### Example 2: Transfer Setting Method Using DNS

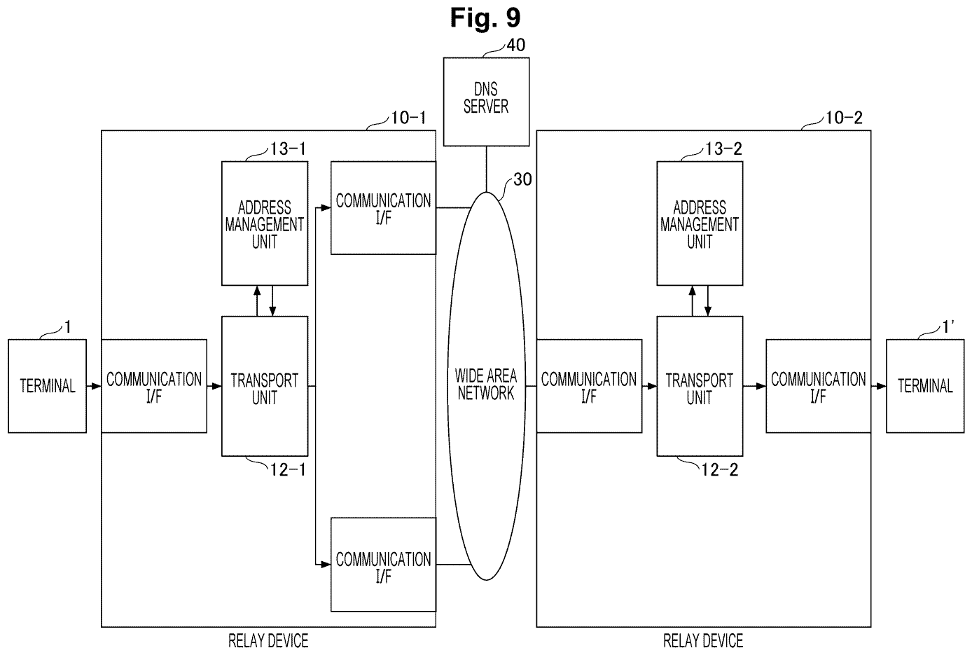

Next, as Example 2, a transfer setting method using DNS will be described. FIG. 9 illustrates a configuration example of a communication system according to Example 2.

As illustrated in FIG. 9, a DNS server 40 is provided, and the relay devices 10-1 and 10-2 are connected to the wide area network 30. The DNS server 40 can communicate with each terminal and each relay device. Unlike the case of Example 1, the relay device 10 in Example 2 does not include the address translation unit 11.

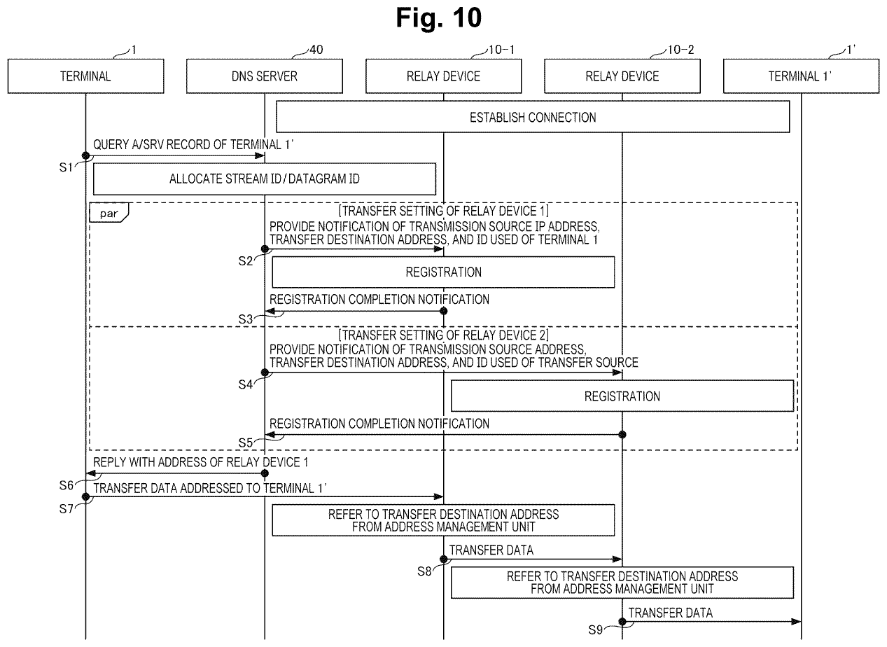

An operation example of the communication system in Example 2 will be described with reference to FIG. 10. Between the relay devices 10, a QUIC connection is established in advance via one or more networks using a protocol such as MPTCP, MPQUIC, or the like.

In S1, the terminal 1 queries the DNS server 40 as to the SRV record of the terminal 1′. The DNS server 40 allocates a stream ID or a datagram ID used in the QUIC connection between the relay device 10-1 and the relay device 10-2 through which the communication from the terminal 1 to the terminal 1′ passes.

In S2 to S5, the DNS server 40 notifies each relay device 10 through which the communication passes of the transfer source address, the transfer destination address, and the ID used for the QUIC connection, and each relay device 10 registers the addresses and ID information in the address management unit 13 and sends a registration completion notification to the DNS server 40.

In S6, the DNS server 40 provides the terminal 1 with the address of the relay device 10-1, not the address of the terminal 1′ as a reply, and in S7, the terminal 1 transfers data addressed to the terminal 1′ to the relay device 10-1. In S8 and S9, the data is transferred. At this time, as for the transfer method, any of the TCP, UDP, and IP methods is used as in Example 1.

In a case where the IP packet is transferred as it is, the port number is unnecessary. Therefore, an A record can be used as a DNS record, and the ID for the QUIC connection is also unnecessary.

In the example illustrated in FIG. 10, the DNS server 40 replies with the address of the relay device 10-1, but may reply with the address of the terminal 1′ and the relay device 10-1 may perform address translation. In this method, communication may pass through two or more relay devices 10, and a freely-selected relay device 10 can be used.

### Hardware Configuration Example

All of the devices (relay device 10 and DNS server 40) described in the present embodiment can be implemented by, for example, causing a computer to execute a program. This computer may be a physical computer or may be a virtual machine on the cloud.

That is, the device can be implemented by executing a program corresponding to the processing to be performed in the device by using hardware resources such as a CPU and a memory included in the computer. The above-described program can be stored and distributed by being recorded in a computer-readable recording medium (a portable memory or the like). Further, the above-described program can also be provided through a network such as the Internet or an electronic mail.

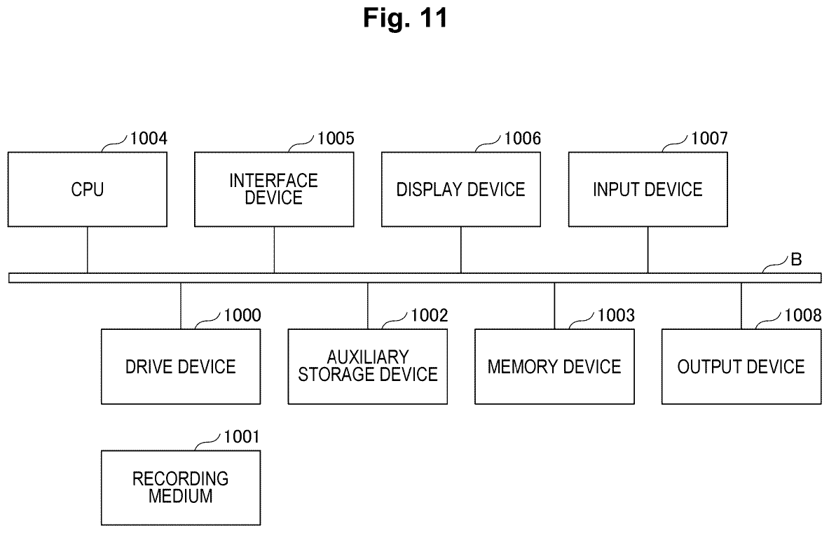

FIG. 11 is a diagram illustrating a hardware configuration example of the above-described computer. The computer in FIG. 11 includes a drive device 1000, an auxiliary storage device 1002, a memory device 1003, a CPU 1004, an interface device 1005, a display device 1006, an input device 1007, an output device 1008, and the like, which are connected to each other by a bus B. Note that the computer may further include a GPU. The auxiliary storage device 1002 and the memory device 1003 may be collectively referred to as a storage device. The address management unit 13 is achieved by using the storage device.

The program for achieving the processing in the computer is provided by a recording medium 1001 such as a CD-ROM or a memory card. When the recording medium 1001 storing the program is set in the drive device 1000, the program is installed from the recording medium 1001 to the auxiliary storage device 1002 via the drive device 1000. However, the program is not necessarily installed from the recording medium 1001 and may be downloaded from another computer via a network. The auxiliary storage device 1002 stores the installed program and also stores necessary files, data, and the like.

In a case where an instruction to start the program is given, the memory device 1003 reads the program from the auxiliary storage device 1002 and stores the program. The CPU 1004 fulfills a function related to the device according to the program stored in the memory device 1003. The interface device 1005 is used as an interface for connection to a network or the like. The display device 1006 displays a graphical user interface (GUI) or the like according to the program. The input device 1007 includes a keyboard and a mouse, a button, a touch panel, or the like, and is used to input various operation instructions. The output device 1008 outputs a computing result.

### Summary of Embodiment

In the communication system of the present embodiment, data transmission is performed between terminals via a plurality of relay devices 10 connected via one or more networks. Communication is terminated in the transport layer (L4) in each relay device 10, and a plurality of pieces of stream communication or datagram communication are multiplexed in one transport connection between the relay devices 10 and transferred via one or more networks.

The relay device 10 translates the destination address of a packet transmitted from a terminal. In addition, the relay device 10 associates original transmission/reception addresses of the packet with a flow identifier used in the transport connection between the relay devices 10, and notifies the counterpart relay device 10 of the flow identifier and the transmission/reception addresses.

Furthermore, the relay device 10 checks whether a fragment identifier of a transfer source packet exists, and in a case where the fragment identifier exists, the transfer source packet can be transferred using the transport connection between the relay devices 10 without changing the transfer source packet.

Furthermore, the relay device 10 can switch the transfer method in the transport connection between the relay devices 10 on the basis of the payload length or the transmission frequency of the transfer source packet. Examples of the transfer method include a method of assigning a flow identifier, a method of assigning transmission/reception addresses, and the like.

In addition, in a case where a DNS query from a terminal is made to the DNS server 40, the DNS server 40 determines a transfer setting for one or more relay devices 10 through which the communication of the terminal passes and a transfer method in a transport connection between the relay devices 10 for the communication of the terminal, and notifies each relay device 10 of information such as a transfer source address, a transfer destination address, an ID used, and the like. Each relay device 10 registers the notified information and uses the registered information at the time of data transfer.

### Effects

With the technology according to the present embodiment described above, it is possible to perform transfer using a plurality of lines even for an application using TCP, UDP, or IP that a proxy in MASQUE or the like and a tunneling protocol as the conventional technologies do not support.

In addition, since encryption, quality control of a plurality of lines, and congestion control can be processed intensively in the relay device, use efficiency of computational resources and use efficiency of networks are improved. In addition, the technology according to the present embodiment enables data transfer without using a higher-level protocol such as HTTP.

In addition, as illustrated in FIGS. 3, 4, and the like in Example 1, the relay device 10 terminates a transport protocol (TCP/UDP) of a source of transfer, and transfers only the payload by a transfer method (QUIC stream/datagram) that conforms to the transport protocol of the source.

As a result, the packet header size can be reduced as compared with a case where the IP/UDP/TCP packet is simply tunneled. Further, in the case of TCP, since traffic control (congestion control or the like) is doubly performed by TCP between terminals and QUIC between relay devices, it is possible to avoid conflict between control operations.

Regarding the above-described embodiment, the following supplementary notes are further disclosed.

### Clauses

### (Clause 1)

A relay device to be included in a communication system including a plurality of relay devices connected via one or more networks, the relay device including
a memory; and
at least one processor connected to the memory,
in which the processor
registers at least transmission/reception addresses of communication between terminals in the memory,
translates a destination address of a packet received from a terminal, and
receives a packet after destination address translation and transfers data of the packet by using a transport connection between the relay devices by referring to the memory.

### (Clause 2)

The relay device according to Clause 1, in which
the processor registers the transmission/reception addresses and a flow identifier used in the transport connection in association with each other, and notifies a counterpart relay device of the transmission/reception addresses and the flow identifier, and
in which the processor terminates a transport protocol of a source of transfer of the packet and transfers only a payload of the packet by a transfer method that conforms to the transport protocol of the source.

### (Clause 3)

The relay device according to Clause 1 or 2, in which
the processor checks whether or not fragmentation of an IP packet received from a terminal is enabled, and transfers the IP packet without performing address translation of the IP packet in a case where the fragmentation is enabled.

### (Clause 4)

The relay device according to any one of Clauses 1 to 3, in which
the processor determines a transfer method for a packet received from a terminal on a basis of a payload length or a transfer frequency of the packet.

### (Clause 5)

The relay device according to any one of Clauses 1 to 4, in which
the processor registers the transmission/reception addresses and a port number used in the transport connection between the relay devices in association with each other, adds a path using the port number, and notifies a counterpart relay device of the transmission/reception addresses by using the path added.

### (Clause 6)

The relay device according to any one of Clauses 1 to 5, in which,
with a query from a terminal to a DNS server as a trigger, the processor receives from the DNS server and registers, address information and a flow identifier used in the transport connection.

### (Clause 7)

A relay method executed by a relay device to be included in a communication system including a plurality of relay devices connected via one or more networks, the relay method including
a step of registering at least transmission/reception addresses of communication between terminals in a storage device,
a step of translating a destination address of a packet received from a terminal, and
a step of receiving a packet after destination address translation and transferring data of the packet by using a transport connection between the relay devices by referring to the storage device.

### (Clause 8)

A non-transitory storage medium storing a program for causing a computer to function as each unit of the relay device according to any one of Clauses 1 to 6.

Although the present embodiment has been described above, the present invention is not limited to such a specific embodiment, and various modifications and changes can be made within the scope of the present invention disclosed in the claims.

### REFERENCE SIGNS LIST

1 to n Terminal
1′ to n′ Terminal
10 Relay device
11 Address translation unit
12 Transport unit
13 Address management unit
20 Network
30 Wide area network
1000 Drive device
1001 Recording medium
1002 Auxiliary storage device
1003 Memory device
1004 CPU
1005 Interface device
1006 Display device
1007 Input device
1008 Output device

1. A relay device to be included in a communication system including a plurality of relay devices connected via one or more networks, the relay device comprising:
a memory; and
at least one processor connected to the memory,
wherein the processor is configured to:
register at least transmission/reception addresses of communication between terminals in the memory;
translate a destination address of a packet received from a terminal; and
receive a packet after destination address translation and transfer data of the packet by using a transport connection between the relay devices by referring to the memory.

2. The relay device according to claim 1, wherein
the processor is configured to register the transmission/reception addresses and a flow identifier used in the transport connection in association with each other in the memory, and notify a counterpart relay device of the transmission/reception addresses and the flow identifier, and
wherein the processor is configured to terminate a transport protocol of a source of transfer of the packet and transfer only a payload of the packet by a transfer method that conforms to the transport protocol of the source.

3. The relay device according to claim 1, wherein
the processor is configured to check whether or not fragmentation of an IP packet received from a terminal is enabled, and transfer the IP packet without performing address translation of the IP packet in a case where the fragmentation is enabled.

4. The relay device according to claim 1, wherein
the processor is configured to determine a transfer method for a packet received from a terminal on a basis of a payload length or a transfer frequency of the packet.

5. The relay device according to claim 1, wherein
the processor is configured to register the transmission/reception addresses and a port number used in the transport connection between the relay devices in association with each other in the memory, add a path using the port number, and notify a counterpart relay device of the transmission/reception addresses by using the path added.

6. The relay device according to claim 1, wherein,
with a query from a terminal to a DNS server as a trigger, the processor is configured to receive from the DNS server and register in the memory, address information and a flow identifier used in the transport connection.

7. A relay method executed by a relay device to be included in a communication system including a plurality of relay devices connected via one or more networks, the relay method comprising:
registering at least transmission/reception addresses of communication between terminals in a storage device;
translating a destination address of a packet received from a terminal; and
receiving a packet after destination address translation and transferring data of the packet by using a transport connection between the relay devices by referring to the storage device.

8. A non-transitory computer-readable storage medium storing a program for causing a computer to perform functions of the processor of the relay device according to claim 1.
